(19) United States
(12) Patent Application Publication
(10) Pub. No.: US 2012/0166172 A1
(43) Pub. Date: Jun. 28, 2012

(54) PROVIDING LEGACY COMPUTING COMPATIBILITY

(76) Inventors: Bruce L. Fleming, Morgan Hill, CA (US); Arvin Mandhani, San Francisco, CA (US); Achmed A. Zahir, Menlo Park, CA (US); Satish B. Acharya, Bangalore (IN)

(21) Appl. No.: 12/977,698

(22) Filed: Dec. 23, 2010

(51) Int. Cl. G06F 13/12

(52) U.S. Cl. 703/21

(57) ABSTRACT

In some embodiments if a transaction is directed at existing hardware, then the transaction is directed to existing hardware. If the transaction is not directed at existing hardware, then the transaction is sent through a behavioral model. Other embodiments are described and claimed.

### TECHNICAL FIELD

The inventions generally relate to providing legacy computing compatibility.

### BACKGROUND

There are mobile processor designs such as System on Chip (SoC) designs that are highly optimized for low power use and specifically designed to target smartphone platforms. Shrink wrap Operating Systems have not been usable in these types of platforms because of issues such as the power, footprint and licensing cost issues. This reduces dependencies of or requirements for personal computer (PC) legacy hardware (for example, an Intel 8259 controller, an 8254 Programmable Interval Timer, an IOxAPIC, a PC Compatible Real Time Clock or PC Compatible RTC, Advanced Configuration and Power Interface or ACPI, etc) which is required for existing and legacy shrink wrap Operating Systems. Since hardware complexity and power impacts are involved in incorporating PC legacy hardware, these items are not typically incorporated into a design for mobility platforms such as smartphones. This is acceptable when Operating Systems such as Moblin, Meego, Android or Windows Mobile are used, since they accommodate a lack of PC compatibility. However, in a low power device that is between a PC and a smartphone (known as a “tweener” device) a low power SoC may be used, but customers typically also would like a shrink wrap Operating System such as Windows included in such a “tweener” platform. Therefore, a need has arisen to provide support for a shrink wrap Operating System such as Windows by providing PC compatibility in such a way as to not impacting the low power use or complexity of the device when it is used in a phone (where microwatts are important).

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a flow according to some embodiments of the inventions.

FIG. 2 illustrates a flow according to some embodiments of the inventions.

### DETAILED DESCRIPTION

Some embodiments of the inventions relate to providing legacy computing compatibility.

In some embodiments if a transaction is directed at existing hardware, then the transaction is directed to existing hardware. If the transaction is not directed at existing hardware, then the transaction is sent through a behavioral model.

Legacy hardware that is added to a system as overall power and complexity impact the platform is typically absorbed by the power impact of the Operating System and the overall open platform complexity typical with legacy systems (such as PC platforms). However, this impact is not acceptable for devices such as ultra mobile devices, and therefore requires a better solution to the problem of providing PC compatibility without impacting the power or complexity of the device when it is operating as a phone.

In some embodiments the problem of a device providing PC compatibility without impacting the power or complexity of the same device when it is operating as a phone is specifically addressed and solved. In some embodiments PC compatibility is provided while still maintaining the power savings required for phones.

In some embodiments, unclaimed Input/Output (I/O) cycles are processed and either redirected to existing hardware or a behavioral model of the device is provided. This is directed by I/O accesses performed by software, for example. In some embodiments, this capability is referred to as a “hardware assist”.

According to some embodiments, solutions include hardware trapping logic and firmware which responds to events generated by the trapping logic. The hardware trapping logic exists, for example, at an egress port of an existing fabric in a manner such that it will receive all unclaimed I/O cycles. When the hardware trapping logic is enabled, it will generate an event either to logic or to another processor in the system. In some embodiments, the event is forwarded (for example, in the form of an inter-process communication message or IPC message) to a controller (for example, a 32 bit microcontroller, a system control unit, and/or an SCU). The controller receives a message which includes, for example, the I/O port address, the byte enables, a read/write (MR) indication, and any associated data (for example, associated data from write transactions). The controller determines what actions to do based on the I/O port, which correlates to a specific legacy device such as an Intel 8259 controller, an 8254 Programmable Interval Timer, an IOxAPCI, a Real Time Clock or RTC, Advanced Configuration and Power Interface or ACPI, etc). The controller either redirects to existing hardware in the Memory Mapped Input/Output space (MMIO space) as in the case of RTC, or provides a modeled response to the transaction. Once the controller handles the transaction the hardware trapping logic is programmed with the correct response (including any data for read requests) and the transaction is then terminated by the hardware trapping logic. The software sees a response that is identical to a response that would have been received if accessing a real PC legacy hardware device.

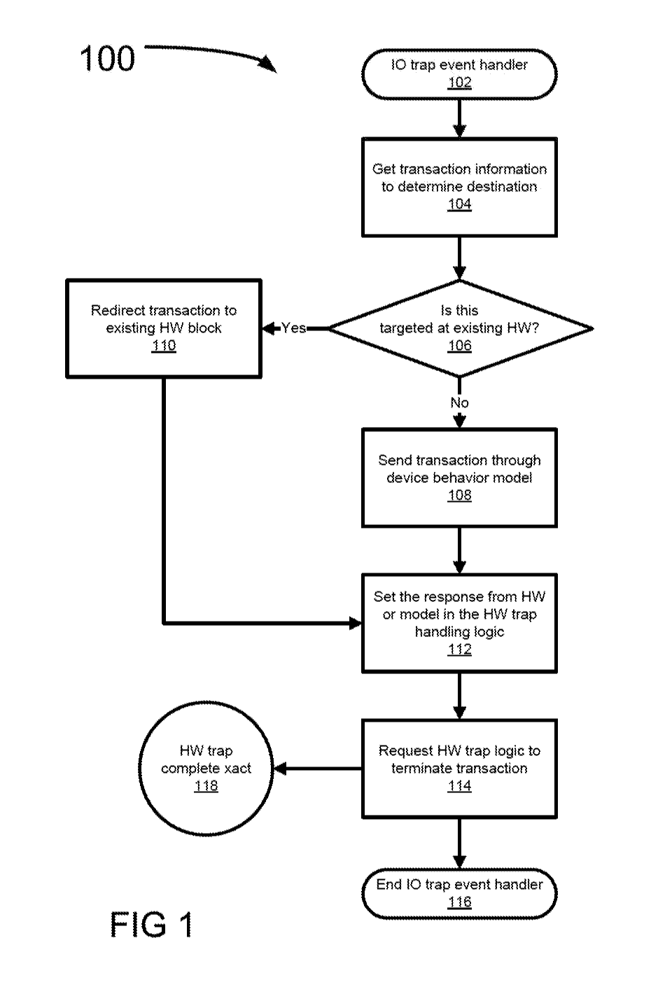

FIG. 1 illustrates a flow 100 according to some embodiments. In some embodiments flow 100 comprises and/or includes a trap handler. In some embodiments an Input/Output (I/O) trap event handler starts at 102. Transaction information is obtained at 104 to determine the destination. At 106 a determination is made as to whether the event is targeted at existing hardware. If the event is not targeted at existing hardware at 106, the transaction is sent through a device behavior model at 108. If the event is not targeted at existing hardware at 106, the transaction is redirected to an existing hardware block at 110. After the transaction is sent through the device behavior model at 108 or the transaction is redirected to the existing hardware block at 110, the response from the existing hardware or the device behavior model is set in the hardware trap handling logic at 112. Then a request is made of the hardware trap logic at 114 to terminate the transaction. Then the I/O trap event handler is ended at 116 and a hardware trap complete transaction is sent at 118.

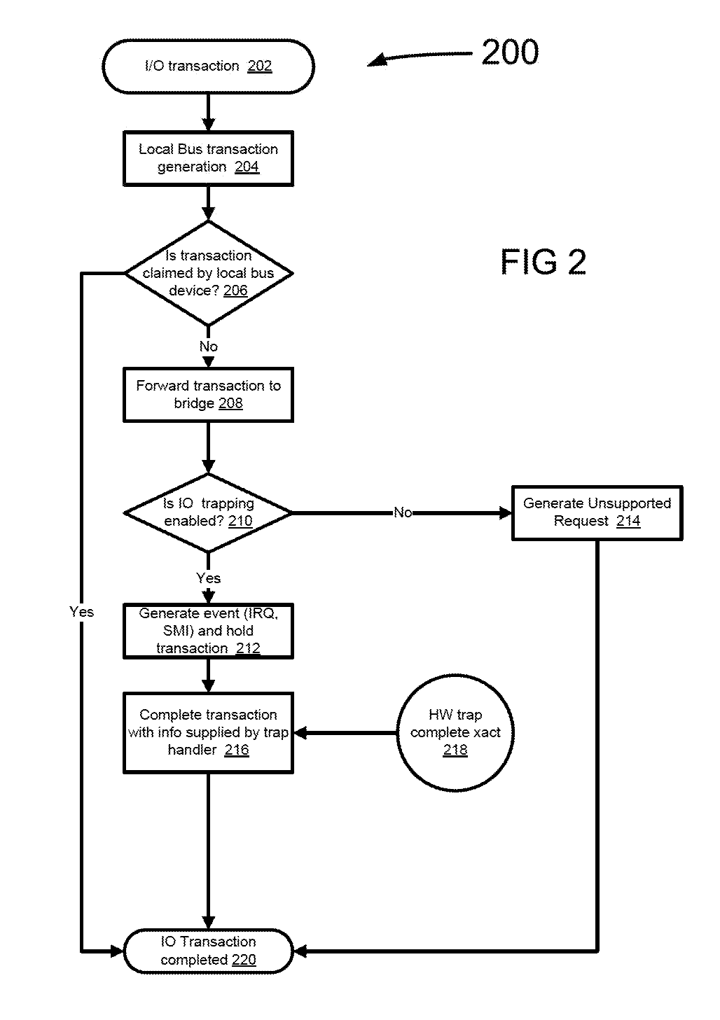

FIG. 2 illustrates a flow 200 according to some embodiments. In some embodiments, flow 200 comprises and/or includes hardware trap logic. An I/O transaction begins at 202. Then a local bus transaction is generated at 204. Then at 206 a decision is made as to whether the transaction is claimed by a local bus device. If the transaction is not claimed by the local bus device at 206, the transaction is forwarded to a bridge at 208. Then a decision is made at 210 as to whether I/O trapping is enabled. If I/O trapping is enabled at 210, an event (for example, an interrupt such as a IRQ or SMI) is generated at 212 and the transaction is held. This event is generated in some embodiments, for example, to either logic or another processor in the system. IF I/O trapping is not enabled at 210, then an unsupported request (UR) response is generated at 214. After the event is generated at 212 the transaction is completed at 216 with information supplied by the trap handler (for, example, the trap handler of FIG. 1). The hardware trap complete transaction 218 provides input to the transaction completion at 216. In some embodiments, the hardware trap complete transaction 218 is the same as and/or is in response to the hardware trap complete transaction 118 of FIG. 1. If the transaction is claimed by the local bus device at 206 flow moves to 220 where the I/O transaction is completed. Similarly, after the transaction is completed at 216 and also after the unsupported request (UR) response is generated at 214 the I/O transaction is completed at 220.

In some embodiments the same set of capabilities is produced as in legacy hardware devices, while maintaining a reduced gate count and therefore lower power (including leakage).

A phone platform typically does not have a 14.318 MHz clock as required for PC compatibility. According to some embodiments, this clock issue is addressed by allowing firmware to provide a behavioral model for timers which transparently scales values based upon the clock frequencies available on the platform.

According to some embodiments, hardware trapping logic and firmware hardware assist are used to provide a solution that is power efficient and provides no impact to power if the PC legacy features are not used (such as, for example, when the device is used in a phone with a mobile operating system.

Although some embodiments have been described herein as being implemented in a particular manner, according to some embodiments these particular implementations may not be required. For example, some embodiments have been described herein as being implemented using an I/O handler. However, some embodiments are not limited to use of an I/O handler. For example, according to some embodiments Memory Mapped I/O (MMIO) trapping may be used.

Some embodiments have been described herein as relating to legacy devices such as an Intel 8259 controller, an 8254 Programmable Interval Timer, an IOxAPCI, a Real Time Clock or RTC, Advanced Configuration and Power Interface or ACPI, etc). It is noted that according to some embodiments these are key legacy functions that can be hardware assisted.

Some embodiments are described herein as being limited or related to processing of “Input/Output (I/O) cycles. However, according to some embodiments, legacy support and/or hardware capability also includes processing of, for example, end of interrupt (EOI) cycles; PCI config cycles; virtual legacy wire (VLW) messages for ACPI power management such as Sx state signaling, SCI, GPE and/or PME events; SMI, NMI, and PCIe assert/deassert INTx messages; and/or SERR for PCIe-compatible error handling. Examples of some of these acronyms include:

SCI=“System Control Interrupt” is an ACPI construct. It is also known as an “ACPI interrupt”.
GPE=“General Purpose Event” is an ACPI construct.
PME=“Power Management Event” a PCIe defined pin

### SMI=“System Management Interrupt”

### NMI=“Non Maskable Interrupt”

INTx=Shorthand for four PCI level-sensitive interrupts. In PCI these were pins, in PCIe they became messages: INTA#, INTB#, INTC#, INTD#
Interrupts are driven low by PCI devices to request attention from their device driver software. They are defined as “level sensitive” and are driven low as an open drain signal. Once asserted, the INTx# signals will continue to be asserted by the PCI device until the device driver software clears the pending request. A PCI device that contains only a single function shall use only INTA#. Multi-function devices (such as a combination LAN/modem add-in board) may use multiple INTx# lines. A single function device uses INTA#. A two function device uses INTA# and INTB#, etc. All PCI device drivers must be capable of sharing an interrupt level by chaining with other devices using the interrupt vector.
SERR=SERR# System Error is for reporting address parity errors, data parity errors during a Special Cycle, or any other fatal system error. SERR# is shared among all PCI devices and is driven only as an open drain signal (it is driven low or tri-stated by PCI devices, but never driven high). It is activated synchronously to CLK, but when released will float high asynchronously through a pull-up resistor.
ACPI=“Advanced Configuration and Power Interface” which is defined by the Advanced Configuration and Power Interface Specification

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may, “might”, “can” or could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
if a transaction is directed at existing hardware, then directing the transaction to existing hardware; and
if a transaction is not directed at existing hardware, then sending the transaction through a behavioral model.

2. The method of claim 1, further comprising providing legacy computer compatibility while maintaining power savings required for phone use.

3. The method of claim 1, further comprising processing unclaimed input/output cycles.

4. The method of claim 1, further comprising performing hardware trapping.

5. The method of claim 4, further comprising responding to events generated by the hardware trapping.

6. The method of claim 4, wherein the hardware trapping receives unclaimed input/output cycles.

7. The method of claim 1, further comprising generating an event if hardware trapping is enabled.

8. The method of claim 1, further comprising completing the transaction in response to a trap handler.

9. An apparatus comprising:
a controller adapted to receive unclaimed input/output cycles and adapted to direct a transaction to existing hardware, or if the transaction is not directed at existing hardware, then adapted to send the transaction through a behavioral model.

10. The apparatus of claim 9, the controller adapted to provide legacy computer compatibility while maintaining power savings required for phone use.

11. The apparatus of claim 9, the controller adapted to perform hardware trapping.

12. The apparatus of claim 9, wherein the controller includes hardware trapping logic.

13. The apparatus of claim 9, the controller adapted to respond to events generated by the hardware trapping.

14. The apparatus of claim 9, the controller adapted to generate an event if hardware trapping is enabled.

15. The apparatus of claim 9, the controller adapted to complete the transaction in response to a trap handler.
